(19) United States
(12) Patent Application Publication
(10) Pub. No.: US 2002/0062253 A1
(43) Pub. Date: May 23, 2002

(54) Loyalty club reward system for use in a broadcast loyalty program

(76) Inventors: Sidney Dosh JR., Crystal River, FL (US); Gordon Peek Smith, Ocala, FL (US)

Correspondence Address: Law Office of Thomas C. Saitta, P.A., Suite 203, 6821 Southpoint Dr. North, Jacksonville, FL, 32216, US

(21) Appl. No.: 10/039,445

(22) Filed: Oct. 19, 2001

Related U.S. Application Data
(60) Provisional application No. 60/241,830, filed on Oct. 20, 2000.

(51) Int. Cl. G06F 17/60

(52) U.S. Cl. 705/14

(57) ABSTRACT

A method and system involving Smart Card technology, point of sale computer terminals, computer servers, and systems of consumer purchasing at disparate member merchant and vendor locations, where sales transactions are recorded and rewarded by redeemable points to encourage brand loyalty and increased spending with the member merchants and vendors.

This invention claims the benefit of U.S. Provisional Patent Application Serial No. 60/241,830, filed Oct. 19, 2000.

### BACKGROUND OF THE INVENTION

This invention relates generally to the field of business methods and processes involving Smart Card technology and systems of consumer purchasing at disparate member merchant and vendor locations, where sales transactions are recorded and rewarded to encourage brand loyalty and increased spending with the member merchants and vendors, and where local market radio stations act as administrators and promoters of the program.

Prior to the invention as disclosed herein, most value-based Smart Card applications in the United States have been limited to stored value transactions issued by banks and banking associations such as Visa, Master Card, and American Express. The consumer oriented loyalty point market offers a substantial opportunity that is completely untapped to date.

Smart Cards, consisting of microprocessors embedded into a small wallet-sized plastic card with an electronic strip, were first patented in France in 1974. Consequently, most of the historic usage of Smart Cards has been concentrated in Europe. Currently, the U.S. and Asian markets represent less than 10% of world Smart Card usage, but are projected to utilize 40% of the 3.27 billion cards to be produced in 2001. Applications in the United States have been limited to stored value transactions issued by banks and banking associations such as Visa, Master Card, and American Express.

The Broadcast Loyalty Club Program's Smart Card market concept is based upon a web-based, layered system Smart card available from companies with proprietary software. The Smart Card is a wallet-sized plastic card with an embedded, computer chip carrying a myriad of accessible data retrievable on demand and capable of fully integrating a variety of everyday functions with strict security features.

Utilizing Smart Card properties, loyalty program merchants will have access to important consumer data, including consumer buying habits, product preferences, price ranges, and contact information. Consumers will be afforded continuing discounts and special sale opportunities through the accumulation of loyalty points, much like a frequent flyer program or an electronic green stamp program.

The elements of the program include, involving a local radio station as the means of administering and promoting the program, putting local businesses and consumers first, developing nationwide distribution of the program through participating radio stations, consistently exceeding investor expectations, and operating with high ethical standards.

In today's global economy, with online sales four times as high in 1999 as 1998 and with new projections that over half of US adults will buy online, local radio stations will be an essential source for high impact, low cost advertising. Radio has been in the past, and will continue to be in the future, an important ingredient for local businesses, particularly if they hope to compete in the expanding global economy. The key to holding market share is to find new and innovative ways to drive consumers to buy from local stores. Local businesses have one important advantage over other non-local purchases—service. Returns, credits, adjustments, repairs and personal contact are only available to local consumers at stores they can walk into and talk with sales and service personnel. If there is a disadvantage, it lies in the area of competitive pricing, which will be overcome through the Broadcast Loyalty Club Program. The Broadcast Loyalty Club Program will solve all of these problems for local businesses by making participating merchants a household name, through the process of echoic retention—the repetitive audio presentation of the business name through radio advertising—by offering consumers a compelling reason to buy first at home, by creating nontraditional sales opportunities over the Internet, and by putting the merchant in touch with a large buying group with incentives to buy from participating merchants.

Since the introduction of the Smart Card, numerous improvements and types have found their way into the market. Smart Card computer chips are specified in two ways, functionality and computing capacity. From a functional mode there are Read-only chips (memory), Read-only, write once chips (EPROM), and Read-only, write many times chips (EEPROM).

Due to the fact that over 90% of all Smart Cards used have been for telecommunications, production of Smart Cards worldwide has been skewed towards simple memory cards. All industry analysts suggest that the trend will change over the next five years, with memory cards giving over to microprocessor cards.

The growth of Smart card technology and usage in the United States has been predicted for some time. It is expected that Smart card use will result in improved efficiency and cost savings over the current swipe-card technology applications. The growth in Smart card use in the US has been hampered, however, due to several factors. The cost benefits have been hard to realize. In order for Smart Card usage to increase, there needs to be an established infrastructure, which will support their use. Until the number of cards in use increases, the infrastructure will not grow and the end result is the classical technology “catch 22.” Infrastructure as used here refers to readers and systems that will support the cards at the point of sale. Until that infrastructure is built up, Smart cards will get limited use—and therefore cost more.

The “catch 22” is further complicated by the fact that the current standards for the cards deal with the mechanical and electrical specification of the cards and not the software architectures which support them. No effective open standards yet exist which will drive the card manufactures to common application design standards. The result is that the systems, which are being, fielded, are proprietary and will not interface with one another. This means that the systems, which are fielded, are embedded with a proprietary data structure and do not contribute to a common reusable infrastructure. When the system is implemented, the developer becomes enslaved by the proprietary operating system based on the card they have chosen. The overall result is that the growth of the infrastructure, which is needed to allow card prices to drop, is again hampered by card manufacturers for the simple reason that by establishing a proprietary system, they can control the price of the cards. There is little incentive for this to change on the part of the card manufacturers.

System hardware for reading information and making applications that run with Smart Card chips are developed for either open environments or closed environments. The VISA Cash pilot at the 1996 Summer Olympics in Atlanta was an example of an open environment because terminals were placed in the public domain and vendors accepted VISA Cash along with all other forms of currency. A closed system is where all points-of-sale are controlled by one vendor and Smart Card stored value is the only form of currency accepted. The closed user environment is what this system embraces because transaction revenues can be guaranteed.

There are a number of international standards for the physical configurations of Smart Cards. The International Standards Organization (“ISO”) has promulgated a series of rules regarding how Smart Cards are to be manufactured (ISO 7816). However, the marketplace has heretofore governed software for the utilization of Smart Cards. Accordingly, any number of software developers have proprietarily devised everything from operating systems to data storage. There is a movement afoot initiated by the banking associations to standardize software configuration and data placements for financial transactions. These standards are referred to as EMV (Europay, MasterCard, and Visa). The EMV standard allows for multiple developers to format and develop applications that can be managed through the current banking infrastructure. All EMV software must be registered, tested, and authorized by one of the three associations prior to certification.

The open/closed environmental debate will be determined by the ability for software from different issuers to be read by any reader in any location. This ability is known as interoperability. Interoperability allows a Visa Cash card to be read and a transaction to be made on an American Express “Proton” reader. The need for having a set of standards will pave the way for mass propagation of readers into the consumer market. An ample comparison would be banking and ATM networks. The current state of the Smart Card industry is that several “banks” are creating proprietary software products for use within their closed “markets”. After the consumer market demanded that ATM cards become interoperable, “network” providers such as “HONOR”, “CIRRUS”, “MAESTRO”, and others closed the gap and now anyone virtually anywhere can use an ATM card in almost any ATM. This is the convenience and power of a consumer-driven market standard.

Another battle is being fought over intercompatability. This refers to having the ability of loading software from various issuers onto a card. For example, a resident of Orlando may belong to the Chamber of Commerce, who issues a Smart card from source “A”. The resident may also have season tickets to the Orlando Magic basketball team, issued by source “B”. Intercompatability will allow for that resident to load the Magic tickets from source B onto the card issued from source A. Many industry experts believe that the Java programming language will become the standard by which all of these intercompatable issues will be managed. Time will tell; most likely the market will settle on a de facto standard that will be embedded in chips as compared to a software “add-on.”

As with any new technology, particularly relating to money or personal information, security is an area of prime concern. Great pains have been taken by the designers and application developers to maintain the integrity and security of proprietary payment platforms. Regulatory agencies from around the globe have issued standards and transaction protocols, which ensure that counterfeit and fraud are more difficult to perpetrate than with cash notes. Security of confidential patient information is a great concern in the medical industry. Several states are proposing legislation to benefit the consumer. The problems addressed by the legislation are threefold:

1. How to devise a system to overcome the public's lack of confidence in maintaining the integrity of private data?

2. How to prevent unauthorized persons from viewing and altering sensitive data?

3. How to authenticate a cardholder's identity and thereby prevent fraud within the system?

There are a number of security issues relating to Smart cards:

1. ISO 7816 Standards. The International Standards Organization (“ISO”) has issued numerous rules on Smart Card production and security. Not only do the ISO rules standardize the issuance and specifications of Smart cards, but they also delineate how Smart cards will be formatted and personalized.

2. US Federal Reserve Regulation “E”. The Federal Reserve System regulates all monetary interchange within the US. The “Fed” has proposed guidelines relating to reporting and usage of non-monetary units such as electronic cash. Regulation “E”, as proposed, states that accounting procedures must be in place to audit and account for transactions above a specified level, currently $100.

3. Data Encryption Standard (DES). Early Smart Card technology had the capability of utilizing DES for the encryption and decryption of specified text. This technology supports 64-bit block size and uses a 56-bit key during encryption. DES is utilized in the authentication processes within electronic purse Smart Cards (other than in Canada and in the United States).

4. Public-Key Cryptography. With the advent of Public-Key Smart Card technology, Smart Cards can be used for both encryption and authentication. Keys are stored in highly secure files on the Smart Card. Each individual uses a recipient's Public-Key to send a message. The receiver will then use his or her Private-Key to decrypt the message. Using this technology prevents the sharing of Secret Keys (Private-Keys).

5. Issuer Security. Issuers can and do create proprietary security features on Smart Cards. Data can be either in open or closed areas. Closed areas require additional digital keys to access the secured data. This data would include financial data, personal data and medical data. The additional keys required to access the data on the closed area of a Smart Card are math computations involving multiplication of fourteen digit numbers. The odds of randomly calculating the numbers are in the billions-to-one ratio.

The security systems built into Smart Cards have proved to be impregnable thus far. All parties involved can take comfort in the fact that Smart Card technology is a quantum leap in convenience and security over current systems. In short, the security offered by Smart Cards far exceeds that of other electronic means. Because data is portable and personal, there is no one system to crack. Additionally, no one person or group has the ability to create value or steal value from cards. Smart Card issuers are regulated by governmental agencies for reporting and financial auditing. LSP will follow each of the federal and international regulations and comply with all reporting standards.

### SUMMARY OF THE INVENTION

In this case the Broadcast Loyalty Club Program will issue “frequent buyer points” a sort of electronic green stamp program. Consumers will enroll as Loyalty Club members at participating merchants. The sequence of events, for example, is as follows:

1. Consumer fills out Smart Card membership form at participating merchants and pays $5 to cover membership origination costs.

2. The new member receives 175 points at the time he or she signs-up.

3. Loyalty Club members will receive 1 point for each $1 purchased from participating merchants. Points will be add and balances maintained in the “chip” on the Smart Card

4. Loyalty Club members can use the points accumulated to get discounts at participating merchant locations. Merchants will set redemption point limits and special product sales rules.

5. The radio station will develop “remote” broadcast events at participating merchant locations to create consumer events. New members will be signed up at these events and special discounts will be given to existing members

6. Points can be redeemed at any participating merchant location—an important and unique aspect that is available only with Smart Card technology.

The administrator will enjoy a continuing stream of revenue as consumers purchase goods and services from local participating merchants. The income will come from three areas:

1. Revenue is generated as Loyalty Club members buy goods and services from local participating merchants.

a) As points are recorded on a member's Smart Card (via a recording POS terminal), the merchant incurs a cost of 5¢. (Note: This may vary in subsequent franchise areas.)

b) Merchants upload the activity daily or weekly to a central server (“bank”) at the administrator's offices. The merchant is billed for the activity and pays the administrator for accumulated activity.

c) When members redeem points to obtain discounts or to buy special sale items, the merchant receives a credit of 3¢ for each point redeemed. The points are deducted from the Smart Card chip and stored in the POS terminal pending uploading to the administrator's bank. The bank nets out the sale of points and the redemption of points for each merchant to determine the amount owed by a merchant or the point credit total in a merchant account.

2. Smart Cards are sold to members at a cost of $5 per card. Advertising will be sold for the back of the Smart Card to defray costs, causing a gross $5 per card profit for the administrator.

3. Franchise fees can also be charged to radio stations that want to host the Broadcast Loyalty Club Program in subsequent markets. These fees could range from $25,000 to $50,000 per market.

In order to ensure that the system is competitive, an Application Program Interface (API) which supports system architecture at the card service layers has been developed. The patented layered system architecture allows for a quick, time to market solutions for the customers. The system is designed to ensure inter-operability and inter-compatibility of applications, which allows them to “Plug-and-Play.” They work with one another and may be used in various combinations with one another.

At the heart of the architecture are the service layers, which are supported by Common Services Infrastructure (CSI). The CSI provides services, such as application object and screen management, the Data Base Management System (DBMS) and communications between system components. The DBMS systems are client server-based, object oriented design which run on both Windows 95 and NT 4.0. The DBMS provides core data management functions such as reports, data backups, and metrics, which can be custom tailored to fit reporting requirements.

The use of architecture layering has also allows implementation of an object-oriented methodology at the application layer. This allows “Plug-and-Play” objects to be added. The applications are designed to work either as stand-alone applications or as multiple functions on a single card.

The architecture also allows for the addition of custom graphics to the system in order to make them unique for each customer. Each product can be personalized to include not only a user friendly interface for a customer's employees and their customers, but also a user recognizable front end tailored to their business. The systems use a screen manager, which allows for change of appearance to fit the customers' operational needs. This feature is most apparent in Smart Card based information kiosks.

The approach is truly unique at the card layer of our architecture. An API has been developed, which is used to isolate the application layer and Common Services Infrastructure layers from the card interfaces. By doing this the application is not dependent on the individual card manufacturers and allows the systems to be more competitive since the life cycle cost of the systems can be lowered.

Architecture of the processing and data storage node is the brain center of all operations. Linked computers (some partitioned for certain functions) manage the disparate operations and link them together through a series of mathematical algorithms and redundant reporting procedures. Scalability of application software and node capabilities played a key role in the original design of the hardware system. Software code is written in Delphi, C++, and JAVA and is actuated through a Windows NT operating system. Movement of data is managed into and out of the SQL database via Microsoft Access.

In one sense, the invention is a method of utilizing computers for rewarding customer loyalty within a merchant membership system comprising the steps of:

(A) enrolling individual members;

(B) providing said members with microprocessor-embedded smart cards capable of maintaining point balances;

(C) enrolling merchants, said merchants being providers of goods or services to said members;

(D) providing said merchants with point of sale computer terminals capable of interacting with said smart cards;

(E) providing a loyalty bank computer server in communication with said point of sale computer terminals such that information can be processed between said loyalty bank computer server and said smart cards;

(F) providing software for said loyalty bank computer server such that said smart cards of said members are credited with points whenever a non-points purchase of goods or services is made and such that said smart cards of said members are debited whenever goods or services are purchased by redeeming said points, through a loyalty club database maintained within said loyalty bank computer server,

and possibly further comprising some or all of the steps of:

(G) providing memory means through software in said point of sale computer terminals to record and store member transactions;

(H) providing automatic communication means in said point of sale computer terminals to contact said loyalty bank computer server to transfer said recorded and stored member transactions;

(I) providing a web server to provide account and information services to said members and said merchants via secure web pages;

(J) providing transaction handler software for said loyalty bank computer server to communicate with said point of sale computer terminals;

(K) providing member account services software for said loyalty bank computer server to verify information contained on said smart cards;

(L) providing merchant services software for said loyalty bank computer server to verify merchant information;

(M) providing management services software for said loyalty bank computer server to process new member, new merchant and other system accounting.

Alternatively, the invention can be described as a system for rewarding customer loyalty within a merchant membership system comprising in combination and in operative communication:

(A) computer means for enrolling individual members;

(B) microprocessor-embedded smart cards capable of maintaining point balances;

(C) computer means for enrolling merchants, said merchants being providers of goods or services to said members;

(D) point of sale computer terminals capable of interacting with said smart cards;

(E) a loyalty bank computer server in communication with said point of sale computer terminals such that information can be processed between said loyalty bank computer server and said smart cards;

(F) software for said loyalty bank computer server such that said smart cards of said members are credited with points whenever a non-points purchase of goods or services is made and such that said smart cards of said members are debited whenever goods or services are purchased by redeeming said points, through a loyalty club database maintained within said loyalty bank computer server;

and possibly further comprising some or all of:

(G) software memory means in said point of sale computer terminals to record and store member transactions;

(H) automatic communication means in said point of sale computer terminals to contact said loyalty bank computer server to transfer said recorded and stored member transactions;

(I) a web server to provide account and information services to said members and said merchants via secure web pages;

(J) transaction handler software for said loyalty bank computer server to communicate with said point of sale computer terminals;

(K) member account services software for said loyalty bank computer server to verify information contained on said smart cards;

(L) merchant services software for said loyalty bank computer server to verify merchant information;

(M) management services software for said loyalty bank computer server to process new member, new merchant and other system accounting.

Also alternatively, the invention is a method of utilizing computers for rewarding customer loyalty within a merchant membership system comprising the steps of:

(A) enrolling individual members by inputting information into management services software embedded within a loyalty bank computer server;

(B) providing said members with microprocessor-embedded smart cards capable of maintaining point balances inputted thereon through computer software;

(C) enrolling merchants by inputting information into management services software embedded within a loyalty bank computer server, said merchants being providers of goods or services to said members;

(D) providing said merchants with point of sale computer terminals capable of interacting with said smart cards through software;

(E) providing a loyalty bank computer server in communication with said point of sale computer terminals such that information can be processed between said loyalty bank computer server and said smart cards, providing management services software for said loyalty bank computer server to process new member, new merchant and other system accounting, said management services software being embedded within said loyalty bank computer server;

(F) providing software for said loyalty bank computer server such that said smart cards of said members are credited with points whenever a non-points purchase of goods or services is made and such that said smart cards of said members are debited whenever goods or services are purchased by redeeming said points, through a loyalty club database maintained within said loyalty bank computer server, and crediting and debiting said smart cards when such purchases occur;

(G) providing memory means through software in said point of sale computer terminals to record and store member transactions, and recording and storing said transactions when such occur;

(H) providing automatic communication means in said point of sale computer terminals to contact said loyalty bank computer server to transfer said recorded and stored member transactions, and contacting said loyalty bank computer server to transfer said transactions;

(I) providing a web server to provide account and information services to said members and said merchants via secure web pages, and providing said account and information services when requested;

(J) providing transaction handler software for said loyalty bank computer server to communicate with said point of sale computer terminals, and communicating with said point of sale computer terminals as required;

(K) providing member account services software for said loyalty bank computer server to verify information contained on said smart cards, and verifying such information as required;

(L) providing merchant services software for said loyalty bank computer server to verify merchant information, and verifying such merchant information as required.

### BRIEF DESCRIPTION OF THE DRAWINGS

FIG. 1 is a schematic of the Loyalty Club Reward System illustrating the components of the POS terminal, web server and Loayalty Bank Server.

### DETAILED DESCRIPTION OF THE INVENTION

The following terms will be used in this document:

Members: Members are consumers that are enrolled in the Loyalty Club Reward System (LCRS).

Points: Points that are earned by Members when they make a purchase and redeem for merchandise.

Merchants: Merchants are businesses that are participating in the LCRS.

The purpose of the LCRS is to gain customer loyalty with merchants by rewarding Members with points when they make purchases at merchants. In return, merchants will offer discounts or prizes that Members can obtain by redeeming their points.

Businesses that decide to participate in the Broadcast Loyalty Program (BLP) are entered to the LCRS as merchants. Each merchant will be supplied with Point of Service (POS) terminals. The terminals main functions will be to award and redeem Member's points.

Members are enrolled in the BLP by completing a membership enrollment form, which is manually entered into the LCRS. Members will be issued a smart card for maintaining a point balance. When a Member purchases goods and services from merchants, merchants will award the Member with points that will be added to their smart card balance. When a Member redeems points at a merchant, the merchant will deduct points from the member's smart card balance.

The merchant is charged a transaction fee for each point that is awarded to a member's smart card. For each point a merchant redeems, the merchant will receive transaction credits. At the end of a billing cycle, the merchant's transaction fees and credits will be totaled for a net balance. If a Merchant's transaction credits exceed their transaction fees, the Merchant will be paid for the difference. If a Merchant's transaction fees exceed their transaction credits, the Merchant will be billed for the difference.

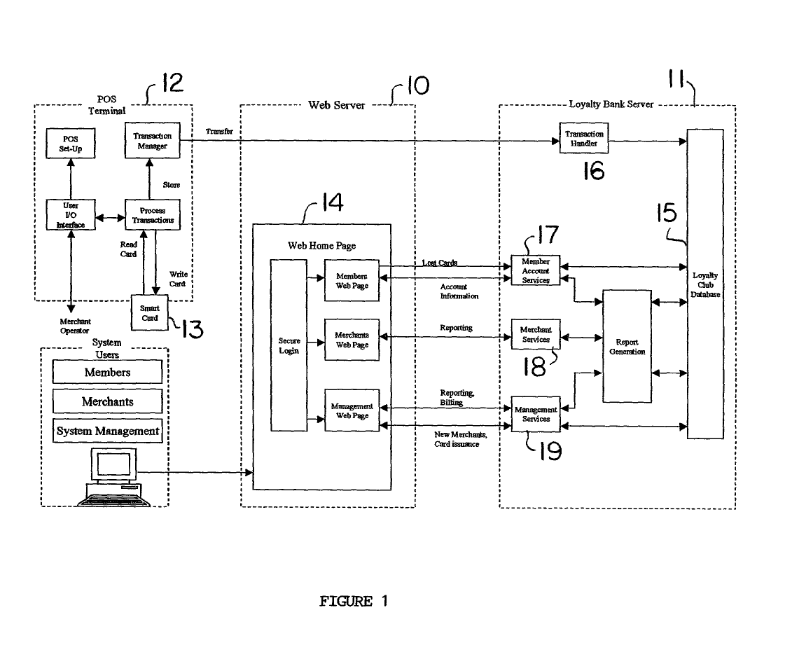

The LCRS, as depicted in FIG. 1, consists of a Web Server 10 interface, Loyalty Bank Server 11, Point of Service (POS) terminals 12 and microprocessor smart cards 13. The Web Server 10 and Web Pages 14 provide the “user” interface to the system. The Web Server 10 is securely tied to the Loyalty Bank Server 11. The Loyalty Bank Server 11 is responsible for maintaining the “bank”. The Web Server 10 provides the link between the Loyalty Bank Server 11 and the remote POS terminals 12.

The purpose of the web server 10 is to provide account and information services for all system users. System users are Members, Merchants and System Managers. The web server 10 will provide a secure page for Members to view their account information such as itemized transactions at merchant locations and Point balance. Members will be required to login by entering their Member ID and password. Members will have the capability to report a lost or stolen card.

The web server 10 will provide a secure page to generate and view reports such as itemized transactions of awarded and redeemed points, spending patterns by Member demographics, and billing information. Merchants will be required to login by entering their Merchant ID and password.

The web server 10 will provide a secure page to allow system administrators and managers to access various functions of the LCRS. System managers will be required to login by entering their User ID and password. The functions they can perform will be limited by their access privileges. The functions that may be performed are:

1. Enter and configure new merchants.

2. Enter new member data.

3. Merchant and Member account maintenance.

4. Generate statistical reports.

5. Generate billing invoices.

The Loyalty Bank Server 11 is a Pentium Personal Computer running the LCRS software applications. The Loyalty Club Database (LCDB) 15 is responsible for maintaining all LCRS data. This data includes:

1. Merchant information (name, address, phone, merchant ID, etc.).

2. Member information (name, address, phone, member ID, etc.).

3. Issued Smart Cards 13 (card ID, status, etc.).

4. Loyalty Transactions (date and time, merchant ID, transaction type, card ID, point value, etc.).

5. Billing and payment information (date, amount, method, etc).

The major software components are: (1) Transaction Handler 16, (2) Member Account Services 17, (3) Merchant Services 18 and (4) Management Services 19. These components are responsible for processing requests and interfacing with the LCDB 15.

The Transaction Handler 16 software component receives requests from the POS terminals 12 to upload Loyalty transactions from the POS terminals 12. Each transaction will be written to the LCDB 15. When all transactions from a single POS terminal 12 have been written to the database 15, an upload complete message will be sent back to the POS terminal 12.

The Member Account Services 17 software component is responsible for verifying Member logins, processing lost or stolen cards 13, and account reporting:

1. When a Member attempts to login into the LCRS, Member Account Services 17 will verify the Member's ID and password.

2. When a lost or stolen card 13 request is received, Member Account Services will inactivate the card 13 in the LCDB 15.

3. If a Member is logged-in and requests account information, Member Account Services 17 will process the request.

The Merchant Services 18 software component is responsible for verifying Merchant logins and processing requests for account reporting;

1. When a Merchant attempts to login into the LCRS, Merchant Services 18 will verify the Merchant's ID and password.

2. If a Merchant is logged-in and requests account information, Merchant Services 18 will process the request.

The Management Services 19 software component is responsible for processing requests for new Merchants and Members, account maintenance, statistical reporting and billing:

1. When Management Services receives a new Merchant or Member request, the Merchant's or Member's account data will be written to the LCDB 15.

2. Management Services 19 will process all Merchant and Member account maintenance requests and write the updated data to the LCDB 15.

3. Management Services 19 will process all requests for reports and billing.

Loyalty POS terminals 12 will be provided to merchants. The Loyalty POS terminals 12 will be portable and independent of any existing POS terminals or cash registers. They can run on batteries or power supply and do not need to be connected to a phone line at all times. Terminal Operators will be required to logon the terminal before the terminal can be used. The Loyalty terminals 12 will have embedded software loaded to process the keypad inputs and LCD (liquid crystal display) outputs, set-up and administer the POS terminal 12, control the process of issuing and redeeming points and control the uploading of transactions to the Loyalty Bank Server 11.

Each POS terminal 12 will have a keypad and LCD for controlling and displaying POS terminal 12 operations and messages. “Special” keys and/or key sequences will be used to navigate through the terminal's functions. The terminal operator will be guided through each terminal operation by text messages.

During installation, the system installation representative with special access rights will set-up the POS terminal 12 with a personalized merchant and location identifier as specified in the LCDB 15. Once the terminal is set-up and operational, a merchant administrator with access rights will have the capability to perform some additional administration functions.

The merchant administrator will have the capability to select whether Points are awarded or deducted from a Member's card 13 by manually entering point values or by using pre-programmed keys. The merchant administrator will have the capability to program a “special” key or key sequence for Loyalty products and redemption prizes with their assigned point value. The POS terminal 12 will provide Point Award and Point Redemption counters. These counters are similar to a cash register's total sales value. For every transaction and every point that is awarded or redeemed, these counters will increment. These counters are provided for “book-keeping” purposes. At the end of each day, it is expected that these counters will be cleared similar to a cash register. The merchant administrator will have the capability to clear the Point Award and Point Redemption counters.

When a Loyalty Member purchases a product/service or redeems Points for a Loyalty Item, the steps needed to complete the transaction are as follows:

1. The sales clerk will insert the member card 13 into the POS terminal 12 and the reader will automatically read the card 13.

2. The sales clerk will select whether this transaction is an “award” or “redemption”.

3. Depending on the set-up parameters, the sales clerk can enter the point value or press one of the programmed keys. The LCD will display the entered point value.

4. The sales clerk will be prompted to validate if the point value is correct. If validated, the transaction will be stored and the Member's new Loyalty Point total will be written to the card 13. When the write card operation is completed, the sales clerk will be notified. If not validated, the sales clerk can re-enter the point value.

5. The sales clerk will return the member card 13.

For most transactions, the sales clerk will only need to make three operations involving the keypad and the entire read-enter-write process will take less than 10 seconds.

The POS terminal 12 will store loyalty transactions in the terminal's memory as they occur until the termiinal's memory capacity is full. Once full, the terminal will display a message indicating that the memory is full and no new transactions will be allowed until the terminal has uploaded the stored transactions. The terminal will automatically dial-up the Loyalty Bank Server 11 and transfer the stored transactions. During this operation, the POS LCD will display a message indicating the transfer is in process. After the transfer has completed successfully, the terminal's memory will be cleared. If the transfer is unsuccessful or the phone line is not connected, the POS LCD will display a message indicating the transfer failed. The terminal operator will have the capability to manually initiate the transfer operation at any time.

To attract interest in the BLP, mobile Kiosks will be provided to LCI so that Members and non-members can play one of the Kiosk games. Two types of games will be provided. One will be an interactive sports trivia game (football) and the other will be a lottery game. The Kiosk software will support other sports trivia games that can be added in the future with little or no software changes. The kiosk system administrator will have the capability to select which kiosk game will be the game of the day.

The kiosk games will consist of a lively presentation utilizing audio, video, graphics, and animation. Kiosk players will navigate through the game utilizing button icons on a touch screen display. The players will have a set amount of time to respond to the game prompts or the kiosk system will reset to the opening screen “teaser”. The amount of time before a reset occurs will be adjustable by a kiosk system administrator.

While the system is not being used, the screen will display an advertisement “teaser” screen. The teaser screen will consist of areas for displaying an advertiser's name and/or logos, digitized video (.AVI files), and a button to begin the game. The advertisers name and/or logos will be displayed on all game screens. The digitized video will play continuously until the game begins. When the begin game button is pressed, the player will move to the player verification screen.

This screen will verify that the player is authorized to play. Every player can only play once within an allotted time. The allotted time (in hours) will be adjustable by a kiosk system administrator. Members will be prompted to insert their member card into the card reader. The kiosk software will verify that the member has not played within the allotted time. If the member has already played, a “sorry” message will be displayed inviting the member to play at a later date and time. After a short delay, the kiosk software will reset and the teaser screen will appear. If the member has not played, the kiosk software will start the game.

Non-members will be prompted to enter their temporary player identification number. The kiosk software will verify the player's identification number and that the player has not played within the allotted time. If the player has already played, a “sorry” message will be displayed inviting the player to play at a later date and time. After a short delay, the kiosk software will reset and the teaser screen will appear. If the player has not played, the player will move to the next screen.

If the kiosk system administrator has enabled the player profile questionnaire, the player will be prompted to answer a series of questions. For each question, a set of multiple choices will be displayed for the player to select one answer. As the player answers the prompted questions, the answers for the player will be saved in a database. When the player has finished the questionnaire, the kiosk software will move to the next screen. The kiosk system administrator will have the capability to select the player profile questions, number of questions and the available answers.

The game welcome screen will appear when the player has been verified and the profile questionnaire has been completed (if enabled by the kiosk system administrator). The Welcome screen will describe “How to Play” the game. When the player is ready to play, the player will touch the “Continue” button to start the game.

Before the game begins, the player will be prompted to select the level of difficulty (Amateur, Semi-Pro, Pro). When the game begins, the player will be challenged by different questions related to sports trivia. As each question is answered, the display will indicate if the question was answered correctly. As the player proceeds, the questions will become more difficult. At the end of the game, a field goal kicker will kick the ball through the uprights if the questions were answered correctly or kick it wide for incorrect answers.

The questions database will contain data fields for questions, multiple choice answers (3) and difficulty rating (1-9). The questions database will be easily modifiable. The kiosk system administrator will also have the capability to select a different questions database. Questions from the database will be randomly selected by the kiosk software based on the level of difficulty selected by the player. For example, if a player selected the “Amateur” option and three questions will be asked, the first question will be randomly selected from all difficulty “1” questions; question two will be randomly selected from all difficulty “2” questions; and, question three will be randomly selected from all difficulty “3” questions.

The player will need to answer a set number of questions before they are rewarded. Only Members can be rewarded with a prize or points for correct answers. The reward may be set to reflect any number of prizes specific to the remote location advertiser or sponsor. The reward will be printed out as a coupon that can be redeemed by the player. The value of a reward will depend on the difficulty of the questions.

The lottery game screen will prompt the player to enter a set of numbers (3-6 numbers) ranging from 1 to the maximum number allowed. The maximum number allowed and the set number will be adjustable by the system administrator. For example, if the set number and maximum number are configured as 3 and 30 respectively, the player will be prompted to enter 3 numbers ranging from 1 to 30. When the player is satisfied with his entered numbers, the player will press a spin button that will randomly generate and display the computer's picks. The lottery game software will then evaluate the computer's picks with the player's picks to determine the number of matches. The player can be rewarded for any number of matches as determined by the system administrator. The system administrator will have the capability to define, if any, the reward for each number of matches. The reward will be printed out as a coupon that can be redeemed by the player.

The following are requirements for the Loyalty Club Reward System. The system shall include the following items:

1. Loyalty Bank Server 11

The server hardware shall host the Loyalty Bank Server II software and LCDB 15. The server system shall consist of (as a minimum):

a. A 450 MHz Pentium II

b. 128 Meg of RAM memory

c. 10 GB hard drive

d. 56K Modem

e. Ethernet 10/100

f. Microsoft Windows NT 4.0

g. Microsoft SQL Server Database

h. Backup tape or CD drive

Two tabletop trivia game kiosks shall be provided for remote broadcast locations. The kiosks will be fully interactive, touch screen multimedia platforms. The kiosks shall consist of (as a minimum):

a. A 300 MHz Pentium II minimum

b. 64 Meg of RAM memory minimum

c. 4 GB hard drive minimum

d. Ethernet 10/100

e. Touch screen display with minimum viewing size of 15″

f. 640×480, 32,000 colors minimum

g. Sound Blaster compatible audio with integrated speakersh.

h. Keyboard & mouse for system maintenance

i. Coupon printer

The POS terminals 12 shall be portable (battery and power supply operated), shall provide a LCD for displaying loyalty transaction, shall provide a modem, and shall provide a keypad.

The Smart Cards 13 shall be microprocessor based.

Software for the system shall be as follows:

The Loyalty Club Web Interface shall provide the user interface to the Loyalty Club Reward System.

Member Account Services 17:

a. The Member Account Services 17 web interface shall provide a Member login for accessing account information.

b. The Member Login shall require a member ID and password.

c. When a Member login request is received, Member Account Services 17 shall verify the Member's ID and password.

d. Upon verifying a Member's login, if login is valid, Member Services 17 shall display the Member Account web page.

e. When a failed login attempt is encountered, Member Account Services 17 shall display a failed login attempt message.

f. The Member Account Services 17 web interface shall provide Member transaction history reports.

g. The Member Account Services 17 web interface shall provide the capability for a Member to view their accumulated Points balance.

h. Member Account Services 17 shall provide the capability for lost or stolen Member Cards 13 to be reported.

Merchant Services 18:

a. The Merchant Services 18 web interface shall provide a Merchant login for accessing account information.

b. The Merchant Login shall require a merchant ID and password.

c. When a Merchant login request is received, Merchant Services 18m shall verify the Merchant's ID and password.

d. Upon verifying a Merchant's login, if login is valid, Merchant Services 18 shall display the Merchant Account web page.

e. When a failed login attempt is encountered, Merchant Services 18 shall display a failed login attempt message.

f. The Merchant Services 18 web interface shall provide Merchant transaction history reports.

g. The Merchant Services 18 web interface shall provide the capability for a Merchant to view accumulated point balances.

h. Merchant Services 18 shall process data reporting requests.

Management Services 19:

a. The Management Services 19 web interface shall provide a Management login for accessing system information.

b. The Management Login shall require a Management User's ID and password.

c. When a Management login request is received, Management Services 19 shall verify the Management User's ID and password.

d. Upon verifying a Management User's login, if login is valid, Management Services 19 shall display the Management Services 19 web page.

e. When a failed login attempt is encountered, Management Services 19 shall display a failed login attempt message.

f. Management Services 19 shall provide the capability for new members to be added.

g. New member enrollment minimum data shall consist of name, address, date of birth (not mandatory), e-mail address, home, work, and fax telephone numbers,

h. Management Services 19 shall write the member data to the LCDB 15.

i. Management Services 19 shall display a Management web page that is user dependent.

j. When Management Services 19 receives a new Merchant request, the Merchant's account data shall write the Merchant data to the Loyalty Club Database 15.

k. When Management Services 19 receives a read new member request, Management Services 19 shall read the pending “card issuance queue” from the Loyalty Club Database 15.

l. When Management Services 19 receives a write Member card 13 request, Management Services 19 shall write member cardholder information to the Loyalty Club Database 15.

m. Management Services 19 shall process all requests for reports and billing.

Loyalty Club Database 15:

a. The Loyalty Club database 15 shall have a secure protection.

b. The Loyalty Club database 15 shall contain Member Data.

c. The Loyalty Club database 15 shall contain Merchant membership data.

d. The Loyalty Club database 15 shall contain Merchant billing and payment data.

e. The Loyalty Club database 15 shall contain Merchant Operator data.

f. The Loyalty Club database 15 shall track Loyalty transactions for Merchant Point Credits and Redemptions.

g. The Loyalty Club database 15 shall contain Point of Service Terminal 12 data.

h. The Loyalty Club database 15 shall contain issued smart cards 13.

i. Loyalty transactions shall be uniquely identified.

j. The Loyalty Club database 15 shall determine if loyalty transactions have been lost. (i.e., not uploaded from the POS terminals 12).

k. The Loyalty Club database 15 shall maintain a Loyalty Member's point balance.

l. The Loyalty Club database 15 shall maintain a Merchants point credit balance.

m. The Loyalty Club database 15 shall maintain a Merchants point redemption balance.

n. The Loyalty Club database 15 shall maintain Member and Merchant passwords.

o. The Loyalty Club database 15 shall archive transactions.

p. Archived transactions shall be accessible for past account reporting.

Server Transaction Handler 16:

a. The Server transaction handler 16 shall authenticate POS terminal 12 dial-in communications.

b. The Server transaction handler 16 shall verify that all transactions have been successfully uploaded.

c. The Server transaction handler 16 shall download software upgrades to the applicable POS terminals 12.

POS Software (embedded):

a. The POS software shall require the terminal operator to logon the terminal.

b. The POS software shall not interface with any existing merchant POS payment terminals or cash registers.

c. The POS terminal 12 shall be personalized for each Merchant and store.

d. The POS terminal 12 shall be able to award points onto the Member's smart card 13.

e. The POS terminal 12 shall be able to redeem points from the Member's smart card 13.

f. The POS terminal 12 shall prompt the Member for their Personal Identification Number for a point redemption transaction.

g. The POS software shall read from the Member's smart card 13 the Card ID and Member point balance.

h. The POS software shall write to the Member's smart card 13 an updated point balance.

i. The POS terminal 12 shall provide a transaction counter that is incremented for each loyalty transaction.

j. The POS terminal 12 shall store each transaction (Date, Time, Card ID, transaction counter, transaction type, point value, transaction results, terminal operator and the merchant location) in local memory.

k. The POS terminal 12 shall update the terminals point award or point redemption counters for each point awarded or redeemed in a loyalty transaction.

l. The POS terminal 12 shall provide the capability to display the current values of the point award and redemption counters.

m. The POS terminal 12 shall perform an automatic dial-up to the server 11 when the termninal's memory has reached 75% capacity.

n. The POS terminal 12 shall have the capability to dial-up the server 11 when prompted by the terminal operator.

o. When the POS terminal 12 dials up the server, the POS terminal 12 shall authenticate itself to the server 11.

p. When the POS terminal 12 dials up the server 11, the POS terminal 12 shall upload all transactions from local memory.

q. When the POS terminal 12 dials up the server 11 and all transactions have been uploaded successfully, the POS terminal 12 shall remove all transactions from memory.

r. When the POS terminal 12 is in the dial up and transaction transfer mode, the POS terminal 12 shall display status messages on the LCD indicating its progress.

s. When the POS terminal 12 is in the dial-up mode, terminal operation shall be restricted to the dial-up mode only.

t. The POS terminal 12 shall cease to operate when there is not enough memory to hold any more transactions.

u. POS terminals 12 should be capable of receiving new software downloads from the Server 11.

v. POS terminals 12 shall handle situations when a card 13 is removed before the transaction has completed. Messages should appear instructing what the operator/customer must do to complete the transaction.

w. The POS terminal 12 shall handle conditions when transmissions to Server 11 are interrupted.

x. The POS terminal 12 shall verify that Loyalty transactions have been properly uploaded.

y. The POS terminal 12 shall keep a record (log) of failed transactions containing transaction details.

z. The record log of failed POS transactions shall be transmitted back to the Server 11 for processing.

aa. The POS terminal 12 shall verify that the Member card 13 has not been modified fraudulently

bb. The POS terminal 12 shall provide a set-up menu for configuring the POS terminal 12.

cc. The POS terminal 12 set-up menu shall provide the capability to initialize the POS terminal 12 to its default settings.

dd. The POS terminal 12 set-up menu shall provide the capability to set the POS Identifier.

ee. The POS terminal 12 set-up menu shall provide the capability to set date and time.

ff. The POS terminal 12 set-up menu shall provide the capability to set the dial-up phone number.

gg. The POS terminal 12 set-up menu shall provide the capability to configure the terminal 12 for automatic dial-ups to occur at every hour or hour increments.

hh. The POS terminal 12 set-up menu shall provide the capability to program function keys for award and redemption points.

ii. The POS terminal 12 set-up menu shall provide the capability to reset point award and point redemption counters.

Database Reporting:

a. The Report software shall allow members to select from a set of standard reports.

b. The Report software shall generate a transaction history report by member ID.

c. The Report software shall allow merchants to select from a set of standard reports.

d. The Report software shall generate a transaction history report by merchant.

e. The Report software shall generate a transaction history report by merchant store location.

f. The Report software shall generate transaction summary reports by member demographics.

g. The Report software shall allow system managers to select from a set of standard reports.

h. The Report software shall allow system managers to only view reports that they are authorized to view.

i. The Report software shall create reports in HTML format.

Kiosk Software (Trivia Game):

The kiosk software will be a catalyst for the loyalty program by acting as a recruitment tool for new members and an attraction for current Members.

a. The Kiosk Software shall run in a Microsoft Windows environment.

b. The Kiosk Software shall have a Secure smart card 13 login.

c. The Kiosk's smart card 13 login shall recognize an administrator card.

d. While logged on, an administrator shall have the capability to set up the kiosk. The administrator can select a set of trivia questions.

e. The Kiosk's smart card 13 login shall recognize a Loyalty Member's card 13.

f. The Kiosk software shall keep a players log of users that have played the kiosk.

g. An Administrator shall have the ability to clear the players log. If a players name is in the log, they cannot play.

h. The Kiosk software shall ask the player a number of questions specified by the administrator during setup.

i. The Kiosk software shall ask random questions selected from a set of questions specified by the administrator during setup.

j. The Kiosk software shall display an animation of a field goal kicker kicking the ball through the uprights after answering all questions correctly.

k. The Kiosk software shall display an animation of a field goal kicker kicking the ball wide after answering a question(s) incorrectly.

l. The Kiosk software shall require a “remote broadcast location” to be specified by the administrator during setup.

m. The Kiosk software shall keep a record of all the players of the kiosk, the number of points issued to each player, and the “remote broadcast location” of the kiosk where the points were issued.

It is contemplated that substitutions and equivalents for certain elements and method steps set forth above may be obvious to those skilled in the art, and thus the true scope and definition of the invention is to be as set forth in the following claims.

We claim:

1. A method of utilizing computers for rewarding customer loyalty within a merchant membership system comprising the steps of:
(A) enrolling individual members;
(B) providing said members with microprocessor-embedded smart cards capable of maintaining point balances;
(C) enrolling merchants, said merchants being providers of goods or services to said members;
(D) providing said merchants with point of sale computer terminals capable of interacting with said smart cards;
(E) providing a loyalty bank computer server in communication with said point of sale computer terminals such that information can be processed between said loyalty bank computer server and said smart cards;
(F) providing software for said loyalty bank computer server such that said smart cards of said members are credited with points whenever a non-points purchase of goods or services is made and such that said smart cards of said members are debited whenever goods or services are purchased by redeeming said points, through a loyalty club database maintained within said loyalty bank computer server.

2. The method of claim 1, further comprising the steps of:
(G) providing memory means through software in said point of sale computer terminals to record and store member transactions;
(H) providing automatic communication means in said point of sale computer terminals to contact said loyalty bank computer server to transfer said recorded and stored member transactions.

3. The method of claim 1, further comprising the steps of:
(I) providing a web server to provide account and information services to said members and said merchants via secure web pages.

4. The method of claim 2, further comprising the steps of:
(I) providing a web server to provide account and information services to said members and said merchants via secure web pages.

5. The method of claim 1, further comprising the steps of:
(J) providing transaction handler software for said loyalty bank computer server to communicate with said point of sale computer terminals.

6. The method of claim 1, further comprising the steps of:
(K) providing member account services software for said loyalty bank computer server to verify information contained on said smart cards.

7. The method of claim 6, further comprising the steps of:
(K) providing member account services software for said loyalty bank computer server to verify information contained on said smart cards.

8. The method of claim 1, further comprising the steps of:
(L) providing merchant services software for said loyalty bank computer server to verify merchant information.

9. The method of claim 7, further comprising the steps of:
(L) providing merchant services software for said loyalty bank computer server to verify merchant information.

10. The method of claim 1, further comprising the steps of:
(M) providing management services software for said loyalty bank computer server to process new member, new merchant and other system accounting.

11. The method of claim 9, further comprising the steps of:
(M) providing management services software for said loyalty bank computer server to process new member, new merchant and other system accounting.

12. A system for rewarding customer loyalty within a merchant membership system comprising in combination and in operative communication:
(A) computer means for enrolling individual members;
(B) microprocessor-embedded smart cards capable of maintaining point balances;
(C) computer means for enrolling merchants, said merchants being providers of goods or services to said members;
(D) point of sale computer terminals capable of interacting with said smart cards;
(E) a loyalty bank computer server in communication with said point of sale computer terminals such that information can be processed between said loyalty bank computer server and said smart cards;
(F) software for said loyalty bank computer server such that said smart cards of said members are credited with points whenever a non-points purchase of goods or services is made and such that said smart cards of said members are debited whenever goods or services are purchased by redeeming said points, through a loyalty club database maintained within said loyalty bank computer server.

13. The system of claim 12, further comprising:
(G) software memory means in said point of sale computer terminals to record and store member transactions;
(H) automatic communication means in said point of sale computer terminals to contact said loyalty bank computer server to transfer said recorded and stored member transactions.

14. The system of claim 12, further comprising:
(I) a web server to provide account and information services to said members and said merchants via secure web pages.

15. The system of claim 12, further comprising:
(J) transaction handler software for said loyalty bank computer server to communicate with said point of sale computer terminals.

16. The system of claim 12, further comprising:
(K) member account services software for said loyalty bank computer server to verify information contained on said smart cards.

17. The system of claim 12, further comprising:
(L) merchant services software for said loyalty bank computer server to verify merchant information.

18. The system of claim 12, further comprising:
(M) management services software for said loyalty bank computer server to process new member, new merchant and other system accounting.

19. The system of claim 12, further comprising:
(G) software memory means in said point of sale computer terminals to record and store member transactions;
(H) automatic communication means in said point of sale computer terminals to contact said loyalty bank computer server to transfer said recorded and stored member transactions;
(I) a web server to provide account and information services to said members and said merchants via secure web pages;
(J) transaction handler software for said loyalty bank computer server to communicate with said point of sale computer terminals;
(K) member account services software for said loyalty bank computer server to verify information contained on said smart cards;
(L) merchant services software for said loyalty bank computer server to verify merchant information;
(M) management services software for said loyalty bank computer server to process new member, new merchant and other system accounting.

20. A method of utilizing computers for rewarding customer loyalty within a merchant membership system comprising the steps of:
(A) enrolling individual members by inputting information into management services software embedded within a loyalty bank computer server;
(B) providing said members with microprocessor-embedded smart cards capable of maintaining point balances inputted thereon through computer software;
(C) enrolling merchants by inputting information into management services software embedded within a loyalty bank computer server, said merchants being providers of goods or services to said members;
(D) providing said merchants with point of sale computer terminals capable of interacting with said smart cards through software;
(E) providing a loyalty bank computer server in communication with said point of sale computer terminals such that information can be processed between said loyalty bank computer server and said smart cards, providing management services software for said loyalty bank computer server to process new member, new merchant and other system accounting, said management services software being embedded within said loyalty bank computer server;
(F) providing software for said loyalty bank computer server such that said smart cards of said members are credited with points whenever a non-points purchase of goods or services is made and such that said smart cards of said members are debited whenever goods or services are purchased by redeeming said points, through a loyalty club database maintained within said loyalty bank computer server, and crediting and debiting said smart cards when such purchases occur;
(G) providing memory means through software in said point of sale computer terminals to record and store member transactions, and recording and storing said transactions when such occur;
(H) providing automatic communication means in said point of sale computer terminals to contact said loyalty bank computer server to transfer said recorded and stored member transactions, and contacting said loyalty bank computer server to transfer said transactions;
(I) providing a web server to provide account and information services to said members and said merchants via secure web pages, and providing said account and information services when requested;
(J) providing transaction handler software for said loyalty bank computer server to communicate with said point of sale computer terminals, and communicating with said point of sale computer terminals as required;
(K) providing member account services software for said loyalty bank computer server to verify information contained on said smart cards, and verifying such information as required;
(L) providing merchant services software for said loyalty bank computer server to verify merchant information, and verifying such merchant information as required.
